(19) United States
(12) Patent Application Publication
(10) Pub. No.: US 2009/0309752 A1
(43) Pub. Date: Dec. 17, 2009

(54) OBJECT LOCATING SYSTEM HAVING REMOTE CONTROL LOCATOR

(75) Inventors: Chen-Huang Fan, Tu-Cheng (TW); Po-Wei Kuo, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/477,898

(22) Filed: Jun. 3, 2009

(30) Foreign Application Priority Data
Jun. 17, 2008 (CN) 200810302161.0

(51) Int. Cl. G08B 5/22

(52) U.S. Cl. 340/825.36

(57) ABSTRACT

An object locating system comprises a remote control locator and an electronic device. The remote control locator includes a start button, and an electromagnetic-wave emitter. The electromagnetic-wave emitter is configured to emit electromagnetic wave by activation of the start button. The electronic device includes a battery, an electromagnetic detecting unit, a notifying unit and a switch unit. The electromagnetic detecting unit is configured to detect electromagnetic wave emitted by the electromagnetic-wave emitter and induce a current according to the detected electromagnetic wave. The notifying unit is configured to output a locating signal. The switch unit is configured to electrically connect the battery to the notifying unit in response to the induced current, thereby activating the notifying unit.

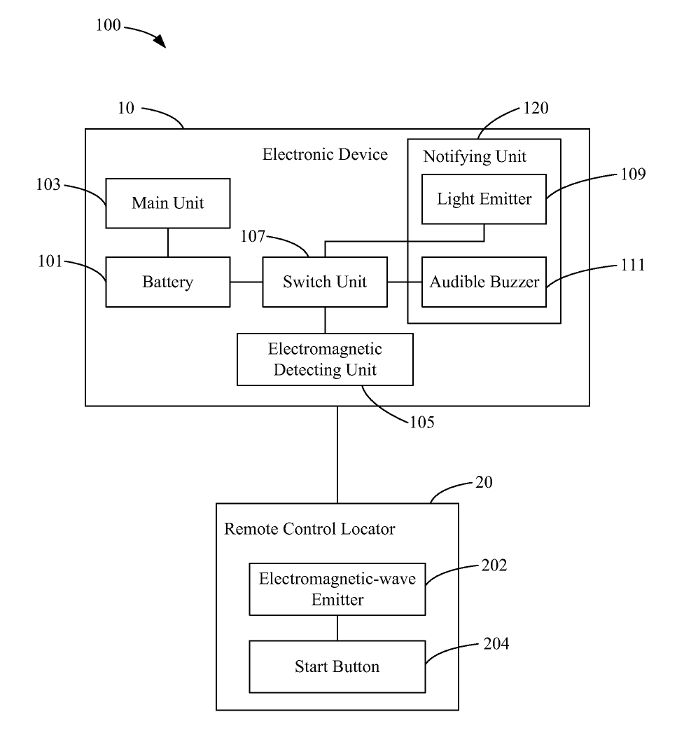

### BACKGROUND

1. Technical Field

The present disclosure relates to locating technology, and particularly, to an object locating system having a remote control locator.

2. Description of Related Art

Portable electronic devices, such as multi-media players and portable gaming devices, are usually misplaced. Upon this condition, time is spent searching for the electronic device. However, this is an inconvenience.

Therefore, an object locating system capable of locating misplaced or lost electronic devices is desired.

### BRIEF DESCRIPTION OF THE DRAWINGS

The FIGURE is a functional block diagram of an object locating system according to an exemplary embodiment.

### DETAILED DESCRIPTION

Referring to the FIGURE, an object locating system 100 includes an electronic device 10 and a remote control locator 20. The electronic device 10 may be a cellular phone, a portable gaming device or a multi-media player or other portable electronic device.

The electronic device 10 includes a battery 101, a main unit 103, an electromagnetic detecting unit 105, a switch unit 107, and a notifying unit 120.

The battery 101 supplies power to the main unit 103. The main unit 103 is configured to implement basic functions of the electronic device 10. For example, for a cellular phone, the main unit 103 may implement a communication function. For a gaming device, the main unit 103 may implement a gaming function.

The electromagnetic detecting unit 105 is configured to detect electromagnetic wave at a certain frequency and induce a current according to the detected electromagnetic wave. The switch unit 107 is configured to electrically connect the battery 101 to the notifying unit 120 in response to the induced current, thereby activating the notifying unit 120. The switch unit 107 may include a transistor or other switches available in the art. A sensitivity of the electromagnetic detecting unit 105 may be preset by a manufacturer of the electronic device 10.

The notifying unit 120 is configured to output a locating signal. In this embodiment, the notifying unit 120 includes a light emitter 109 and an audible buzzer 111. The light emitter 109 may be a light emitting diode. Therefore, once the electromagnetic detecting unit 105 detects the electromagnetic wave, the light emitter 109 and the audible buzzer 111 are activated to assist locating the electronic device. In other alternative embodiment, the light emitter 109 or the audible buzzer 111 may be omitted.

The remote control locator 20 includes an electromagnetic-wave emitter 202, and a start button 204. The electromagnetic-wave emitter 202 is configured to emit electromagnetic wave at the certain frequency by activation of the start button 204. The start button 204 is actuated/depressed to activate the electromagnetic-wave emitter 202. The electromagnetic wave is then detected by the electromagnetic detecting unit 105.

The object locating system 100 adopts an electromagnetic detection to locate the electronic device 10. Therefore, it is convenient to locate the electronic device 10 when misplaced.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An object locating system, comprising:
a remote control locator, comprising:
a start button; and
an electromagnetic-wave emitter configured to emit electromagnetic wave at a certain frequency by activation of the start button; and
an electronic device, comprising:
a battery;
an electromagnetic detecting unit configured to detect the electromagnetic wave emitted by the electromagnetic-wave emitter and induce a current according to the detected electromagnetic wave;
a notifying unit configured to output a locating signal; and
a switch unit configured to electrically connect the battery to the notifying unit in response to the induced current, thereby activating the notifying unit.

2. The system as claimed in claim 1, wherein the notifying unit comprises a light emitter and an audible buzzer.

3. The system as claimed in claim 1, wherein the notifying unit comprises a light emitter.

4. The system as claimed in claim 1, wherein the notifying unit comprises an audible buzzer.

5. The system as claimed in claim 1, wherein the switch unit comprises a transistor.

6. The system as claimed in claim 1, wherein the electronic device further comprises a main unit configured to implement basic functions of the electronic device, the battery supplying power to the main unit.

7. The system as claimed in claim 1, wherein the electronic device is a portable gaming device.

8. The system as claimed in claim 1, wherein the electronic device is a multi-media player.
